(19) United States
(12) Patent Application Publication
(10) Pub. No.: US 2010/0005422 A1
(43) Pub. Date: Jan. 7, 2010

(54) METHOD FOR OPERATING MAP-BASED MENU INTERFACE

(75) Inventor: Fay Wu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/186,536

(22) Filed: Aug. 6, 2008

(30) Foreign Application Priority Data
Jul. 1, 2008 (TW) 97124753

(51) Int. Cl. G06F 3/048

(52) U.S. Cl. 715/841

(57) ABSTRACT

A method for operating a map-based menu interface for a mobile electronic device is provided. In the present method, a map-based menu interface divided into one first type area and n second type areas is provided first, n is a positive integer. At least one function group item is comprised in the first type area, and each of the function group items corresponds to one of the second type areas. Then, a visible region only displaying the first type area is defined. After selecting one of the function group items, the visible region is moved to fully display the second type area corresponding to the selected function group item. As a result, a diverse and interesting manner to operate the menu interface is provided to increase the user experience of the mobile electronic device.

### CROSS-REFERENCE TO RELATED APPLICATION

This application claims the priority benefit of Taiwan application serial no. 97124753, filed on Jul. 1, 2008. The entirety of the above-mentioned patent application is hereby incorporated by reference herein and made a part of specification.

### BACKGROUND OF THE INVENTION

1. Field of the Invention

The present invention relates to a method for operating a menu interface. More particularly, the present invention relates to a method for operating a map-based menu interface for a mobile electronic device.

2. Description of Related Art

With booming development of mobile communication techniques, mobile phones have gradually substitute conventional home telephones to become indispensable communication tools in people's daily life. As to common mobile phone software designs in the market, a hierarchical menu structure is generally used to display various function items of the mobile phone. Generally, a first hierarchy of the hierarchical menu is used for representing a main menu of the mobile phone, which includes various main function group items respectively corresponding to main function groups of the mobile phone, such as communication function group, message function group, setting function group and Internet function group, etc. After a certain function group is entered by selecting a certain function group item, a plurality of sub items of a next hierarchy is then displayed. Therefore, when a user activates a certain function of the mobile phone, he has to repeatedly operate the tree-structure hierarchical menu to find the item corresponding to the desired function.

It is obvious that according to the above operation method, various hierarchies of the menu are required to be repeatedly accessed. Therefore, the user not only spend a lot of time to remember positions of the function items in the menu, but also has to enter the correct submenu step by step to find the corresponding item of the desired function each time when a certain function is activated. Therefore, the user not only feels the operation thereof is tedious, but also has a negative user experience of the mobile phone.

### SUMMARY OF THE INVENTION

Accordingly, the present invention is directed to a method for operating a map-based menu interface, by which a user does not have to repeatedly access various hierarchies of a hierarchical menu, and may easily operate the map-based menu interface having only one hierarchy, so that a facilitate and novel utilization experience can be provided to the user.

The present invention provides a method for operating a map-based menu interface for a mobile electronic device. In the method, a map-based menu interface divided into one first type area and n second type areas is provided first (n is a positive integer). The first type area comprises at least one function group item, and each of the function group items corresponds to one of the second type areas. Then, a visible region that can only display the first type area is defined. After one of the function group items is selected, the visible region is moved to fully display the second type area corresponding to the selected function group item.

In an embodiment of the present invention, before the map-based menu interface is provided, the map-based menu interface is further divided into n+1 grids for respectively representing the first type area and the n second type areas.

In an embodiment of the present invention, the visible region can only fully display the first type area or one of the second type areas at the same time.

In an embodiment of the present invention, the step of selecting one of the function group items includes receiving an item selecting signal, and selecting the function group item corresponding to the item selecting signal.

In an embodiment of the present invention, the step of receiving the item selecting signal further includes obtaining coordinates of the item selecting signal relative to a screen of the mobile electronic device, and judging the function group item corresponding to the item selecting signal according to the coordinates.

In an embodiment of the present invention, the step of moving the visible region to fully display the second type area corresponding to the selected function group item includes displaying all of sub function items included in the selected function group item.

In an embodiment of the present invention, the step of moving the visible region to fully display the second type area corresponding to the selected function group item further includes marking a position of the fully displayed second type area in the map-based menu interface. The step of marking the position includes displaying a menu interface shrunken map formed by shrinking the map-based menu interface according to a specific ratio, and marking the presently fully displayed second type area on the menu interface shrunken map.

In an embodiment of the present invention, the menu interface shrunken map is used for displaying brief drawings or symbols of the first type area and the function group items.

In an embodiment of the present invention, the method further includes moving the visible region along a shortest path between the first type area and the second type area corresponding to the selected function group item.

In an embodiment of the present invention, each of the function group items is an icon of a function group of the mobile electronic device, and the visible region matches a screen size of the mobile electronic device.

In an embodiment of the present invention, the map-based menu interface is a menu interface having only one hierarchy.

In the present invention, the function menu of the mobile electronic device is designed to be a map-based menu interface having only one hierarchy, and a part of content of the map-based menu interface can be displayed by moving the visible region, so that the user may view each of the function groups. By such means, not only repeat access of various hierarchies of the hierarchical menu can be avoided, but also interestingness for operating the mobile electronic device can be improved.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for operating a map-based menu interface according to an embodiment of the present invention.

FIG. 2 is schematic diagram illustrating a map-based menu interface according to an embodiment of the present invention.

FIG. 3 and FIG. 6 are schematic diagrams illustrating a visible region according to an embodiment of the present invention.

FIGS. 4, 7 and 8 are schematic diagrams of a mobile electronic device according to an embodiment of the present invention.

FIG. 5 is a flowchart illustrating a method for selecting a function group item according to an embodiment of the present invention.

### DESCRIPTION OF EMBODIMENTS

To fully convey the concept of the present invention, embodiments are provided below for describing the present invention in detail.

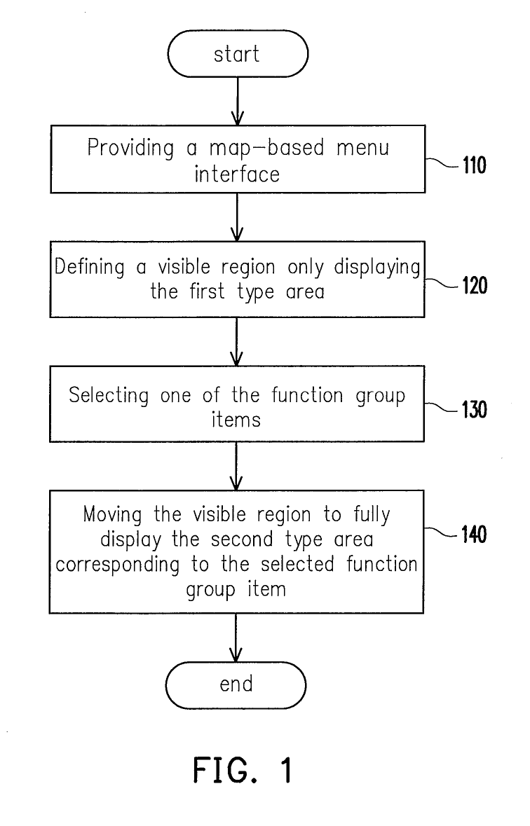

FIG. 1 is a flowchart illustrating a method for operating a map-based menu interface according to an embodiment of the present invention. In the present embodiment, detailed operation steps of the map-based menu interface on a mobile electronic device are described. The mobile electronic device can be a mobile phone, a personal digital assistant (PDA) or a smart phone, etc., which is not limited by the present invention.

Referring to FIG. 1, in step 110, first, a map-based menu interface for the mobile electronic device is provided. The map-based menu interface is a non-hierarchical menu interface (i.e. a menu interface having only one hierarchy), and is divided into one first type area and n second type areas (n is a positive integer). The first type area comprises at least one function group item, and each of the function group items for example represents an icon of each function group of the mobile electronic device. Each of the function group items corresponds to one of the second type areas on the map-based menu interface.

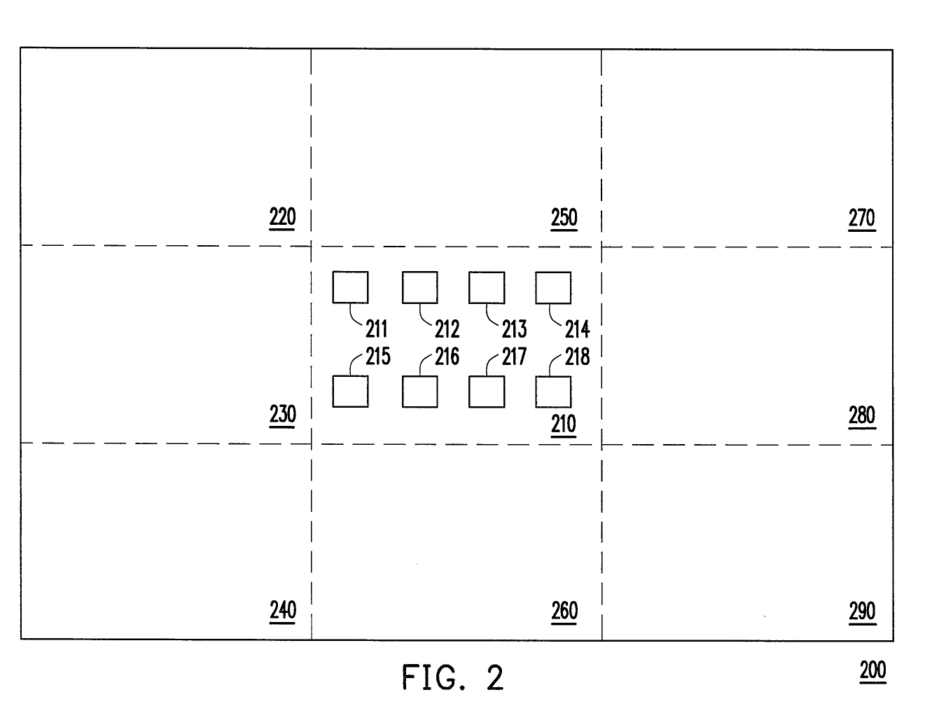

In the present embodiment, the map-based menu interface is divided into n+1 grids respectively representing the first type area and the n second type areas. For simplicity's sake, in the following embodiment, the mobile electronic device is assumed to have 8 main function groups. FIG. 2 is schematic diagram illustrating a map-based menu interface according to an embodiment of the present invention. Referring to FIG. 2, the map-based menu interface 200 includes one first type area 210 and 8 second type areas 220-290. The first type area 210 includes 8 function group items 211-218 corresponding to the function groups of the mobile electronic device. The function group item 211 corresponds to the second type area 220, the function group item 212 corresponds to the second type area 250, the function group item 213 corresponds to the second type area 270, the function group item 214 corresponds to the second type area 280, the function group item 215 corresponds to the second type area 230, the function group item 216 corresponds to the second type area 240, the function group item 217 corresponds to the second type area 260, and the function group item 218 corresponds to the second type area 290. It should be noted that the aforementioned mapping relation between the function group items and the second type areas are only an example. In other words, the above mapping relation is not limited by the present invention.

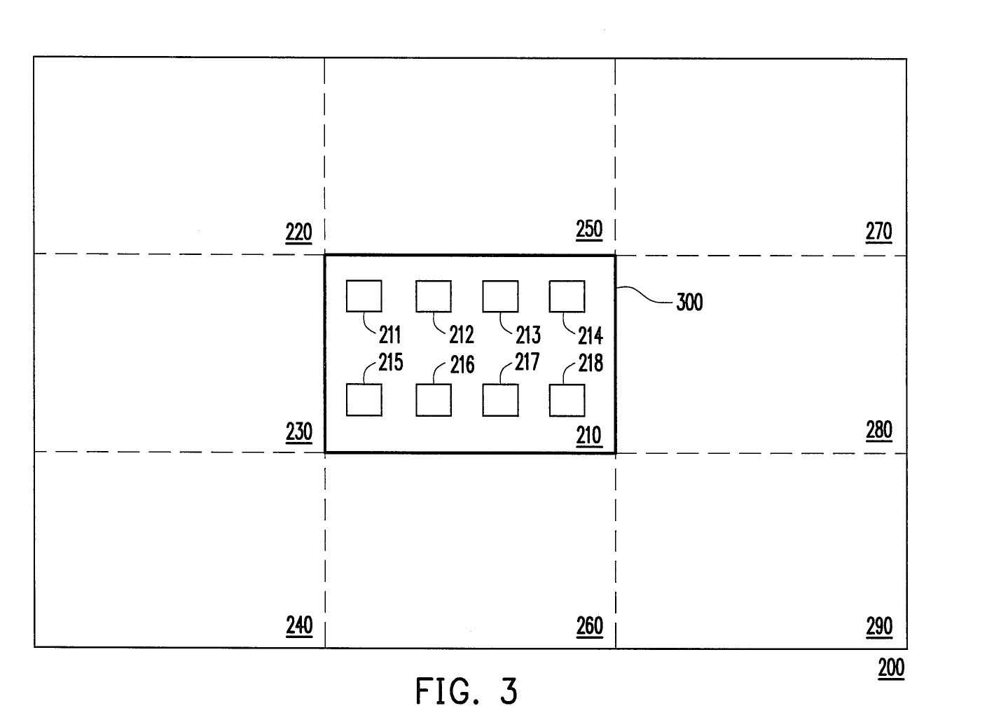

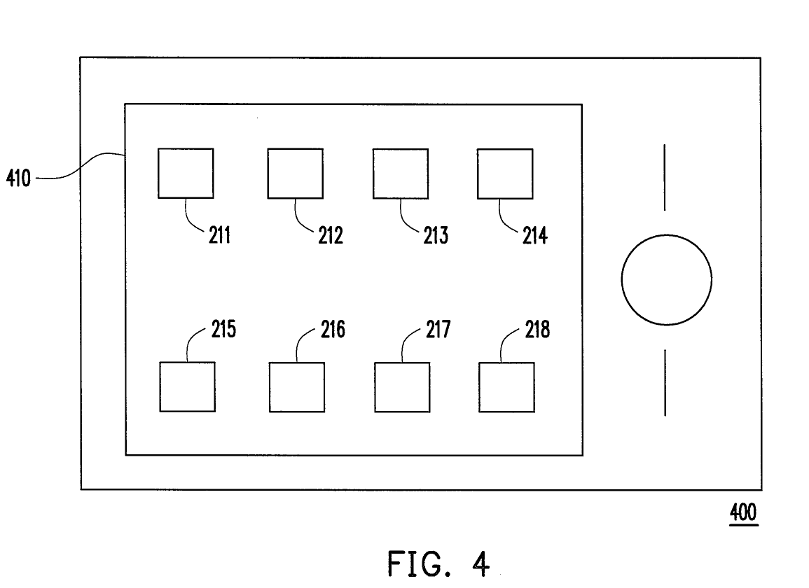

Next, in step 120 of FIG. 1, a visible region only fully displaying the first type area is defined. FIG. 3 is a schematic diagram illustrating a visible region according to an embodiment of the present invention. Referring to FIG. 3, it is obvious that size of the defined visible region 300 is less than that of the map-based menu interface 200. In the present embodiment, the size of the visible region 300 is, for example, matching a size of a screen of the mobile electronic device. FIG. 4 is a schematic diagram of a mobile electronic device according to the present embodiment. Since the size of the visible region 300 matches the size of the screen 410, in the step 120, when a user operates the mobile electronic device 400, he may only view a full content of the first type area 210 on the screen 410. It should be noted that limited by the size of the visible region 300, only the first type area 210 or only one of a second type area on the map-based menu interface 200 can be fully displayed at the same time. Namely, the user can only view a part of the content of the map-based menu interface 200 via the screen 410 at the same time.

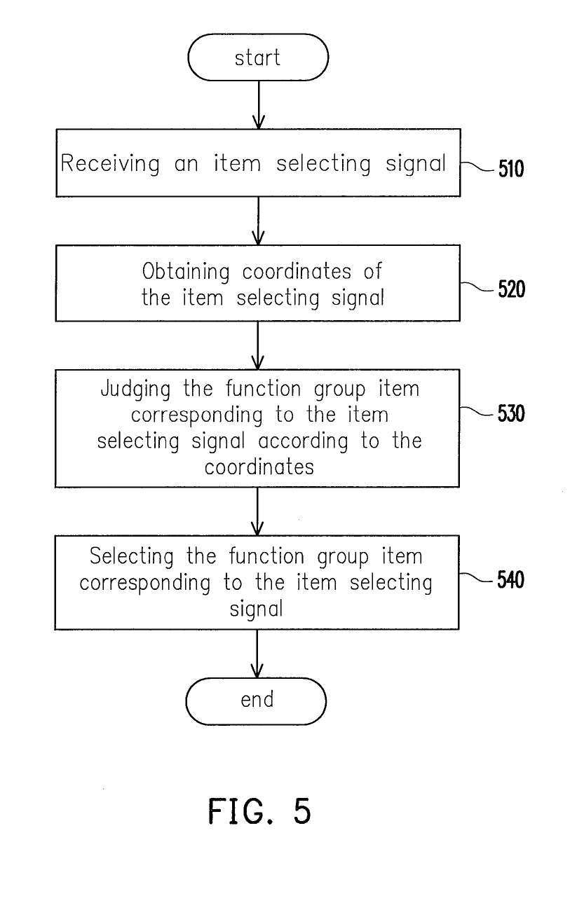

Next, in step 130, one of the function group items in the first type area 210 is selected. FIG. 5 is a flowchart illustrating a method for selecting a function group item. After the step 120 of FIG. 1, the function group items of the mobile electronic device 400 are displayed on the screen 410. Therefore, in step 510, an item selecting signal generated by touching the screen 410 or pressing buttons (not shown) of the mobile electronic device 400 by the user is received.

Next, in step 520, the item selecting signal is converted to obtain coordinates of the item selecting signal relative to the screen 410, and in step 530, the function group item corresponding to the item selecting signal is judged according to the coordinates, so as to determine which function group item is desired to be selected by the user. Finally, in step 540, the function group item corresponding to the item selecting signal is selected.

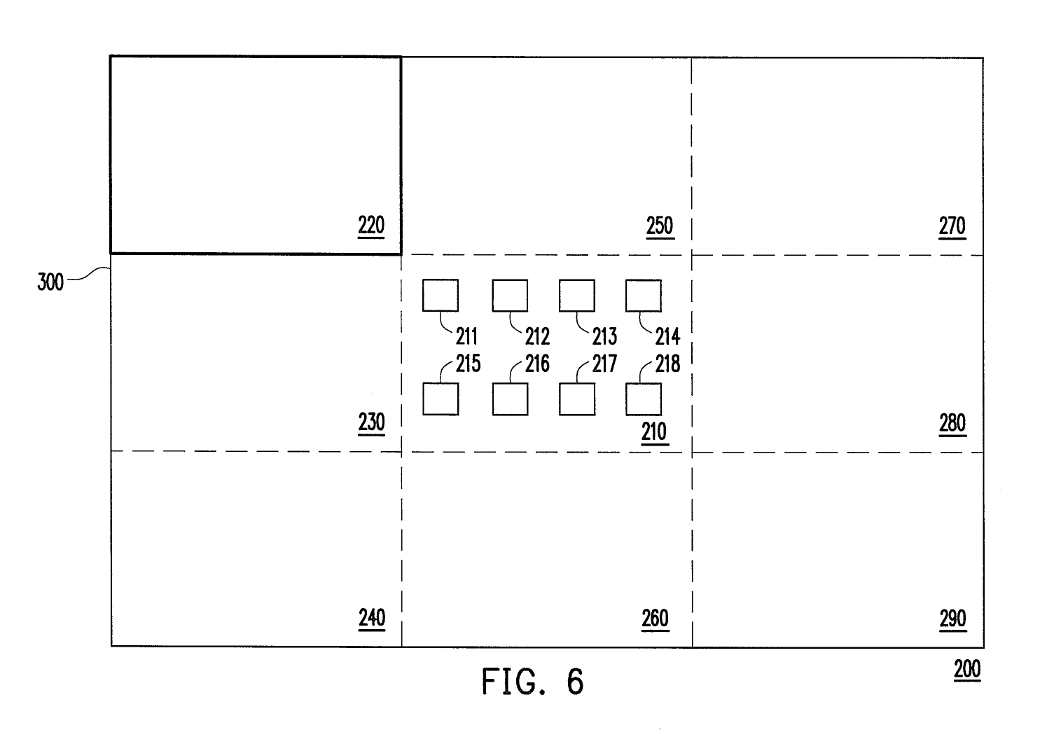

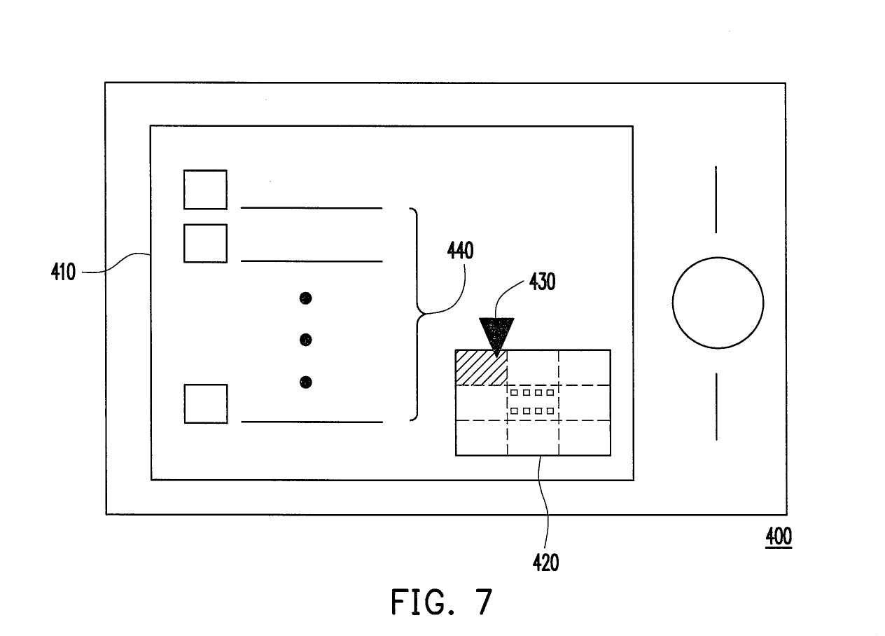

After one of the function group items is selected, in step 140, the visible region 300 is moved to fully display the second type region corresponding to the selected function group item. In the present embodiment, assuming the function group item 211 is selected when the user operates the mobile electronic device 400. Then, as shown in FIG. 6, the visible region 300 is moved from the first type area 210 to the second type area 220 corresponding to the function group item 211. In the present embodiment, the visible region 300 is for example moved along a shortest path between the first type area 210 and the second type area 220. Now, the user may observe an image shown as FIG. 7 on the screen 410 of the mobile electronic device 400.

Referring to FIG. 7, when the visible region 300 is moved to the second type area 220 to fully display the second type area 220, the content displayed on the screen 410 includes all of sub function items 440 of the function group item 211, so that the user can activate a corresponding sub function conveniently.

As shown in FIG. 7, besides the sub function items 440, the user may observe a menu interface shrunken map 420 on the screen 410. A position where the fully displayed second type area 220 is located in the map-based menu interface 200 is marked on the menu interface shrunken map 420 (for example, an area filled by slash lines), and a mark 430 is used for clearly notifying the user which second type area is presently displayed on the screen 410.

Comparing the map-based menu interface 200 of FIG. 2 and the menu interface shrunken map 420 of FIG. 7, it is obvious that the menu interface shrunken map 420 displayed on the screen 410 is formed by shrinking the map-based menu interface 200 according to a specific ratio (for example an equal proportion). Namely, the menu interface shrunken map 420 is used for schematically display the content of the map-based menu interface 200, and the user may obtain the position where an area displayed by the visible region 300 is located on the whole map-based menu interface 200 according to the mark 430.

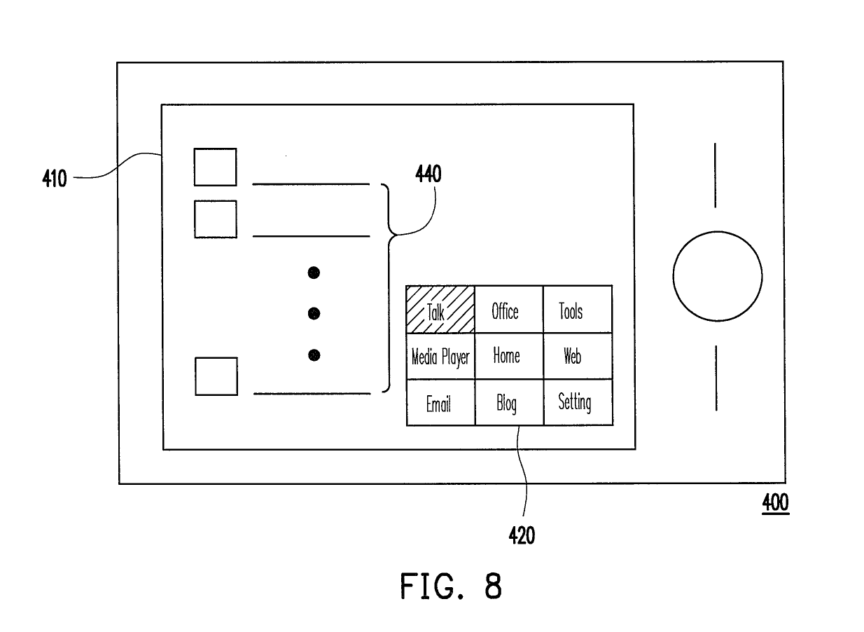

It should be noted that the specific ratio is not limited to the equal proportion. In another embodiment, the menu interface shrunken map 420 is not totally a shrinking version of the map-based menu interface 200. Namely, a length-width ratio of the menu interface shrunken map 420 is not necessarily the same to that of the map-based menu interface 200, and only brief drawings or symbols of the first type area 210 and the function group items are displayed on the menu interface shrunken map 420. Referring to FIG. 8, in the menu interface shrunken map 420 of FIG. 8, the symbol (Home) of the first type area 210 is displayed, and the symbols (i.e. Talk, Office, Tools, Media Player, Web, Email, Blog and Setting) of the function group items 211-218 are displayed. The area filled with slash lines in the menu interface shrunken map 420 represents the position where the fully displayed second type area 220 is located in the map-based menu interface 200.

In the aforementioned embodiment, when the visible region 300 is used for displaying the first type area 210 of the map-based menu interface 200, the user can arbitrarily select the function group items of the first type area 210. The visible region 300 can be moved according to the function group item selected by the user to display the corresponding second type area. Accordingly, though the visible region 300 can only display one area of the map-based menu interface 200 at the same time, the user can still observe all of the content of the map-based menu interface 200 on the screen 410 of the mobile electronic device 400 by moving the visible region 300.

In summary, according to the method for operating the map-based menu interface, the map-based menu interface having only one hierarchy is provided, and the main function group items and the sub function items of the main function group items of the mobile electronic device are disposed in the same hierarchy of the menu. A relatively small visible region confines the user to observe only a part of the contents of the map-based menu interface once a time. The user can move the visible region on the map-based menu interface by selecting a function group item, so as to observe other parts of the contents of the map-based menu interface. Therefore, such operation method is not only interesting but also intuitive and convenient for the user, so that utilization experience of the mobile electronic device can be greatly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating a map-based menu interface for a mobile electronic device, the method comprising:
providing a map-based menu interface, wherein the map-based menu interface is divided into one first type area and n second type area, the first type area comprises at least one function group item, and each of the function group items corresponds to one of the n second type areas, and n is positive integer;
defining a visible region, wherein the visible region only displays the first type area;
selecting one of the function group items; and
moving the visible region to fully display the second type area corresponding to the selected function group item.

2. The method for operating a map-based menu interface as claimed in claim 1, wherein before the step of providing the map-based menu interface, the method further comprises:
dividing the map-based menu interface into n+1 grids for respectively representing the first type area and the n second type areas.

3. The method for operating a map-based menu interface as claimed in claim 1, wherein the visible region can only fully display the first type area or one of the n second type areas at the same time.

4. The method for operating a map-based menu interface as claimed in claim 1, wherein the steps of selecting one of the function group items comprise:
receiving an item selecting signal; and
selecting the function group item corresponding to the item selecting signal.

5. The method for operating a map-based menu interface as claimed in claim 4, wherein the steps of receiving the item selecting signal further comprise:
obtaining coordinates of the item selecting signal relative to a screen of the mobile electronic device; and
judging the function group item corresponding to the item selecting signal according to the coordinates.

6. The method for operating a map-based menu interface as claimed in claim 1, wherein the step of moving the visible region to fully display the second type area corresponding to the selected function group item comprises:
displaying at least one sub function items included in the selected function group item.

7. The method for operating a map-based menu interface as claimed in claim 1, wherein the step of moving the visible region to fully display the second type area corresponding to the selected function group item further comprises:
marking a position of the fully displayed second type area in the map-based menu interface.

8. The method for operating a map-based menu interface as claimed in claim 7, wherein the steps of marking the position comprise:
displaying a menu interface shrunken map formed by shrinking the map-based menu interface according to a specific ratio; and
marking the presently fully displayed second type area on the menu interface shrunken map.

9. The method for operating a map-based menu interface as claimed in claim 8, wherein the menu interface shrunken map is used for displaying brief drawings of the first type area and the function group items.

10. The method for operating a map-based menu interface as claimed in claim 8, wherein the menu interface shrunken map is used for displaying symbols of the first type area and the function group items.

11. The method for operating a map-based menu interface as claimed in claim 1, further comprising:
moving the visible region along a shortest path between the first type area and the second type area corresponding to the selected function group item.

12. The method for operating a map-based menu interface as claimed in claim 1, wherein each of the function group items is an icon of a function group of the mobile electronic device.

13. The method for operating a map-based menu interface as claimed in claim 1, wherein the visible region matches a screen size of the mobile electronic device.

14. The method for operating a map-based menu interface as claimed in claim 1, wherein the map-based menu interface is a menu interface having only one hierarchy.
